(19) United States
(12) Patent Application Publication
(10) Pub. No.: US 2012/0221462 A1
(43) Pub. Date: Aug. 30, 2012

(54) METHOD AND SYSTEM FOR TRADING

(75) Inventor: Peter De VERDIER, Taby (SE)

(73) Assignee: OMX Technology AB, Stockholm (SE)

(21) Appl. No.: 13/466,691

(22) Filed: May 8, 2012

Related U.S. Application Data
(63) Continuation of application No. 11/826,389, filed on Jul. 13, 2007, now abandoned.

(51) Int. Cl. G06Q 40/04

(52) U.S. Cl. 705/37

(57) ABSTRACT

An instrument is traded in an automated exchange system. A first order for the instrument on a first side of a market and a second order for the instrument on a second side of the market are received. The first and second orders are evaluated regarding the possibility for a match between the first and the second orders. If such a match is possible, a preliminary trade is created using the first and the second orders. A third order for the instrument on the first side of the market is received and compared with the first order. If the third order is better than the first order, then the preliminary trade is modified. A final trade is created using the orders currently part of the preliminary trade.

This application is a continuation of U.S. application Ser. No. 11/826,389, filed Jul. 13, 2007, the entire contents of each of which are hereby incorporated by reference.

### TECHNICAL FIELD

The technology relates to a method and an automated exchange system for trading an instrument. In particular, it relates to the determination of a trading price for an instrument traded in an automated exchange system.

### BACKGROUND

Today, many types of instruments are traded by the use of automated exchange systems. Such systems typically create a market for a certain instrument by bringing buyers and sellers of that instrument together. Using programmed computers, in the following referred to as “client computers”, market participants can then enter buy and/or sell orders for the instrument into the system, where a centrally located programmed computer, in the following referred to as a “server computer”, keeps track of the entered orders in an orderbook. The server will continuously apply a set of logical rules to the received orders, trying to find possible matches between buyers and sellers of the instrument. Such a set of logical rules may be termed the “trading state” of the market for the traded instrument. When such a match is found, the corresponding orders are typically removed from the orderbook, where applicable, and a trade is created. Naturally, a trade can also be created using parts of orders, in which case only the affected parts are removed from the orderbook. Also, a trade can be created using orders of which some do not reside in the orderbook, in which case only orders already in the orderbook will be removed from the same.

Orders can be of many different types. Limit orders, for example, have a certain price limit, so that they will only trade with a counter order as long as the price is at least as good as the limit price. These orders typically stay in the orderbook until they are matched with a corresponding counter order, but can also be, for example, time limited. Market orders, on the other hand, do not have a specified limit price. They typically trade instantaneously as they are received, using the best available counter order at the time. If such a counter order is not available, they may, for example, be discarded. Fill-and-kill orders are orders for trading as much as possible of a specified volume at a specified price immediately, and then to immediately cancel any remaining volume of the order. Fill-or-kill orders are similar to fill-and-kill orders, but are only allowed to match completely or not at all.

Many such order types exist in conventional automated exchange systems today.

There are also quotation orders, meaning orders received from market makers with the purpose of making the market in a certain instrument. In the following and when applicable, the term “order” is intended to include both quotation and other types of orders.

Furthermore, many types of instruments are traded in such automated exchange systems. For example, such instrument types include primitive securities such as stocks and bonds, as well as derivative securities, such as stock options, futures, forwards, swaps, etc. They include commodities, such as foodstuffs, livestock, minerals, etc., and derivative instruments of such commodities. Herein, the term “traded instrument” denotes any item that can be traded in an automated exchange system, including both standardized and non-standardized items.

According to one class of trading state-defining sets of logical rules, all orders on the buy side and the sell side, respectively, are continuously ranked according to a certain set of ranking rules, depending on order characteristics such as price, volume, time, participant type, etc. As a consequence of this ranking, one or several of the orders on each side of the market, for example the topmost order on each side, represent the most prioritized order or orders on that side. Typically, the automated exchange system will continuously look for possible matches between the topmost order or orders on each side of the market on the one hand, and incoming orders on the other hand, and generate a trade as soon as a possible match is detected. Such a market is called a continuous auction market. Herein, the term “continuous auction market” is intended to include both order driven, market maker driven, and other types of continuous auction markets. Specifically, a continuous auction market can involve one or several market makers in combination with one or several traders.

In a conventional automated exchange system running a continuous auction market, limit orders will either immediately match other orders already in the orderbook, partially or completely, if such a match is possible, or they will be stored in the orderbook if no such immediate match can be done. In case an order is matched immediately, a trade is normally created using the matched orders. The price of the trade is then determined based upon the matching orders. A trade price can be, for example, the price of the topmost order already in the orderbook, the price of the newly received order, some type of average price for the matched orders, etc.

In a continuous auction market using an automated exchange system, it is often desired to attract as much liquidity as possible, as well as to increase the volumes traded. Also, it is often desired to decrease the risk of the market participants and to create a smooth process of price discovery in the market.

Many methods have been proposed to address the above problems. Notably, some known trading systems achieve increased incentives for participants to provide liquidity, increased trading volumes and/or decreased risk for liquidity providers by the use of certain temporary trading states, that are introduced for example every time a trade is created. During such temporary trading states, certain prioritized participants, normally liquidity providers or aggressors, are given certain rights in relation to other participants.

For example, the U.S. patent application Ser. No. 10/251,717 discloses an automated price improvement protocol processor, in which market participants are encouraged to contribute with liquidity to the market by the introduction of a number of specifically defined time-limited market trading states, in which a liquidity-providing market participant is rewarded in terms of exclusive trading time, priority, etc. For example, it is proposed that the market participant with a topmost order on one side of the market has exclusive rights to trade with a counter-side topmost order during a certain predetermined time. In case someone else trades against such a counter-side topmost order after the expiry of the predetermined time, the topmost market participant on the first side will obtain certain privileges during a second predetermined time period. There are also disclosed mechanisms for increasing the traded volume at a certain trading price once the trading price has been established by a trade between two participants, again by giving certain liquidity-providing participants time-limited privileges as compared to other participants. Finally, the application discloses a method for limiting the risk represented by new orders arriving into the orderbook just before an order is entered into the system by a participant, by the opportunity to optionally choose not to let such recent orders be part of a trade.

Furthermore, the U.S. patent application Ser. No. 10/938,143 discloses a method and a system implementing so-called TTS (Trade-Through-the-Stack) trading rules. Among other things, such rules give prioritized, liquidity-providing participants price guarantees by blocking the cancellation of orders of certain other, non-prioritized participants during certain predetermined time periods under certain conditions. Also, during temporary trading states, during which prioritized participants have exclusive trading rights in relation to non-prioritized participants at an established price level, under certain conditions the price level can change and a new temporary trading state can commence, during which new participants are prioritized. However, trades between two or more participants are priced at a price level which is determined at the time of the trade creation.

In the patent applications discussed above, the advantages in terms of greater liquidity, traded volume, etc., are achieved by altering the trading state of the market, where certain participants are given certain privileges as compared to other participants. By giving such privileges to a subset of participants during certain temporary trading states, prioritized participants are generally required to respond to these privileges by taking the appropriate manual action, namely placing additional volume or the like. In other words, such a participant often has to take active part in the procedures of the temporary trading state in a manual manner in order to take advantage of the associated privileges. Hence, no completely automatic mechanism for achieving the above goals is achieved. This leads to a market where not all participants can take advantage of the rewards for provision of liquidity, etc., since not all participants can be as active in the market as is required for reaping the benefits of the available rewards.

### SUMMARY

It is an object to provide an improved method for trading an instrument in an automated exchange system, whereby market participants are rewarded for providing liquidity to the market and whereby the volume traded is increased.

It is a further object to provide such a trading method whereby the smoothness of the price discovery process is increased.

It is a further object to provide such a method which is completely automatic, and does not require individual market participants to take additional or excessive action in order to be able to exploit certain privileges associated with liquidity providers in the market.

These objects and others are obtained by the technology as set out in the claims.

Generally illustrated by the flow chart in FIG. 2a, and in greater detail in FIG. 2b is a method for trading an instrument in an automated exchange system. The method, preferably but not necessarily running a continuous auction market, involves receiving, during a trading state in which an instrument-specific orderbook is maintained, a first order for the instrument on a first side of the market, which is illustrated at step 102. Also, the method involves receiving, at step 103, a second order for the instrument on a second side of the market. Either one of the first and the second orders can be received before the other. The possibility for a match between the first and the second orders is investigated, as shown at step 104. In case the orders match, a preliminary trade is created, at step 105, with the first and second orders being part of the preliminary trade. Since it is not given on beforehand which one of the first and the second order that is received before the other, either one can be the aggressive order, meaning the order last received and matching an order already received.

In this context, a “preliminary trade” means that the automated trading system makes a note about a possible trade between the first and the second orders, and reserves the corresponding volume of the first and second orders, respectively, but does not accomplish a final trade. A “final trade” means that a trade price is established in the market, and that instructions are generated for the further processing of the trade, such as clearing and settlement.

As shown in FIG. 2b, at step 106, it may be tested whether any of the orders in the preliminary trade is to be partially or completely removed or updated. Also, it may be tested, at step 107, whether a certain condition is fulfilled. In case either test is positive, a final trade may be created, at step 116, either just before the execution of the removal or change operation would have taken place or upon the fulfillment of the condition.

Some time after the creation of the preliminary trade, at step 108, the method comprises the step of possibly receiving a third order for the instrument on the first side of the market. At step 109, the third order is compared to the first order. In case the third order is better than the first order, the preliminary trade is modified, at step 110. At a later point in time, a final trade is created at step 116.

Before the final trade is created at step 116, however, additional tests, regarding whether any of the orders in the preliminary trade is to be partially or completely removed or updated, and whether a certain condition is fulfilled, respectively, may be carried out at steps 111 and 112. In case any of these tests are positive, action may be directed to the creation of a final trade at step 116.

If not, an additional order may be received, at step 113, on either the first or the second side of the market. At step 114, a certain best order is identified as the best order currently being part of the preliminary trade on the same side of the market as the additional order, and the additional order may be compared with the identified best order. If the additional order is found to be better than the certain best order, the preliminary trade may be modified, at step 115, after which action may be transferred back to step 111. If the additional order is not found to be better than the identified best order, action may be transferred directly back to step 111, bypassing step 115.

This way, steps 111 to 115 may be completely or partially repeated several times, until any of the tests at steps 111 and 112 turn out positive.

It is realized that the tests at steps 106 and 107, as well as those at steps 111 and 112, may be carried out repeatedly and continuously, regardless of whether a third order or an additional order is received or not. Thus, after step 105 and while waiting for a possible third order, the tests at steps 106 and 107, respectively, may be carried out in a loop fashion. This way, a final trade may immediately be created at step 116, for example as a consequence of the condition being fulfilled at step 107, whenever the condition is fulfilled, regardless of the amount of time that has passed since step 105 was performed. The corresponding applies to tests at steps 111 and 112, after the steps 110, 114 or 115, but before step 113. This part of the process flow is, however, not shown in the diagrams of FIGS. 2a and 2b, for reasons of simplicity.

The final trade, including the establishment of a trade price, is created, at step 116, using the current orders of the preliminary trade as they stand at the time for the creation of the final trade. The final trade price may be established based upon the prices of these orders, respectively. This may mean that the final trade price is calculated as the best non-aggressor side price, the average price for the best buy- and sell side orders, respectively, or in any other suitable way.

Thus, once a preliminary trade has been created at step 105, the preliminary trade process may continue, receiving first a third and consequently additional orders, checking whether they are better than an order already in the preliminary trade on the same side of the market as the third or additional order, and possibly modifying the preliminary trade, until either test, at step 106, 107, 111 or 112, respectively, turn out positive.

That a certain order is “better” than another order is intended to mean that the certain order is prioritized in some way as compared to the other order, for example through the use of a set of ranking rules as described above. This may mean, by way of example, that a certain order is considered to be better than another order if the certain order is more aggressively priced, has a larger volume, is entered by or on behalf of a more prioritized trading participant or the like, or a combination of the above. Preferably, an order is considered “better” than another order if it is more aggressively priced, in other words if it is a buy-side order with a higher price or if it is a sell-side order with a lower price.

That a preliminary trade is “modified” is intended to mean that one or several of the orders currently being part of the preliminary trade are partially or completely changed, removed or updated. Specifically, this may mean that the first or the certain best order, according to the above, is changed, removed or updated. Preferably, a modification comprises the partial or complete replacement of the first order or the certain best order for a corresponding volume of the third or the additional order, respectively. This way, a third or an additional order, being received after the creation of the preliminary trade, may be introduced in the preliminary trade, replacing an existing order on the same side of the market, in case the more recent order is deemed to be better than the existing order. Preferably, a modification of the preliminary trade may imply that a volume of the third or additional order, respectively, which corresponds to the total volume of the orders in the preliminary trade that are deemed worse than the third or additional order, however at the maximum the volume of the third och additional order itself, may replace the said volume of the said worse orders in the preliminary trade.

An automated exchange system for trading an instrument comprises at least one programmed server computer. The server computer computer is adapted for receiving and managing buy and/or sell orders for the instrument, and may be connected to at least one client computer, adapted for sending such buy and/or sell orders to the server computer. The client computers may be operated by trading participants. Herein, the term “trading participant” is intended to comprise, for example, a human being, some sort of automated trading device, such as algorithmic trading computer software, and the like.

The server computer is adapted for carrying out the steps of the method described above, receiving orders, creating preliminary trades in case of possible matches, as well as creating final trades, possibly upon removal or change of preliminary trade orders or upon the fulfillment of a certain condition.

Finally, a computer program may execute the above method when run on a computer, preferably on the programmed server computer. The computer program may be stored on a computer-readable medium, such as a hard drive or the like, in the server computer 2. However, the computer program may also be run from another location in which it is stored on a computer-readable medium, such as run over a network from another computer having a hard drive, or such as run from a externally connected CD or the like.

### BRIEF DESCRIPTION OF THE DRAWINGS

FIG. 1 is a general view of an automated exchange system;

FIG. 2a is a view generally illustrating a control flow;

FIG. 2b is another view generally illustrating a control flow;

FIG. 3 is a view illustrating an orderbook for a traded instrument at a first point in time;

FIG. 4 is a view illustrating an orderbook for a traded instrument at a second point in time;

FIG. 5 is a view illustrating an orderbook for a traded instrument at a third point in time;

FIG. 6 is a view illustrating an orderbook for a traded instrument at a fourth point in time;

FIG. 7 is a view illustrating an orderbook for a traded instrument at a fifth point in time;

FIG. 8 is a view illustrating an alternative orderbook for a traded instrument at the fourth point in time.

### DETAILED DESCRIPTION

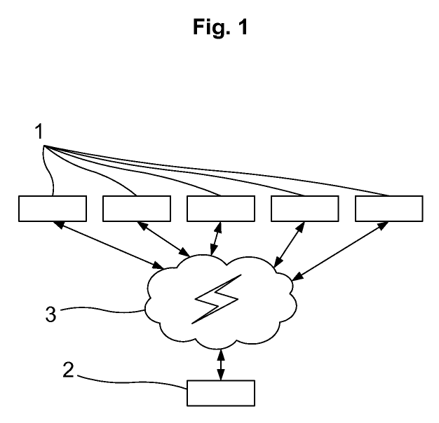

FIG. 1 illustrates an automated exchange system according to the invention, set up for trading at least one instrument, such as a stock, a stock option, a future contract for a certain commodity, a bond, or the like. The system comprises a multitude of client computers 1, all connected to a server computer system comprising at least on server computer 2 via a computer network 3, such as a LAN, a WAN or the like. In FIG. 1, only one server computer 2 is shown. However, it is realized that several such server computers 2 could very well be used for the purpose of the balancing of overall load, distributing specific tasks over different server computers 2, etc.

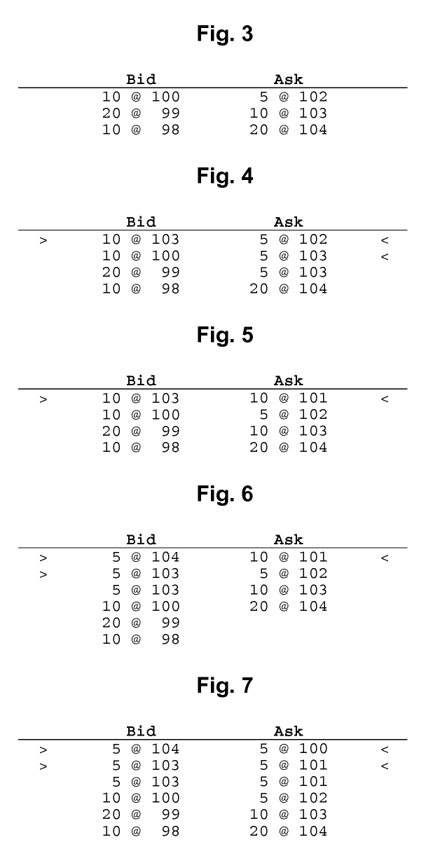

The server computer 2 keeps, at all times, an individual orderbook for each traded instrument. An example of such an orderbook, in this case for the instrument named “X”, is shown in FIG. 3. All orders on each side of the market, respectively, are ordered using a set of order ranking rules. In this exemplifying embodiment (“exemplifying” means a non-limiting example), these ranking rules dictate that orders with better price are placed on top of orders with worse price. That is, on the buy side, higher priced orders go on top of lower priced orders, and vice versa for the sell side. The buy side may also be called the “bid” side, and the sell side may also be called the “ask” side. For orders with the same price, there is a time priority rule stipulating that older orders are placed on top of more recent orders, for both sides of the market. To this end, it is realized that any set of such ranking rules can be used. Exemplifying but not limiting such ranking rules include ranking rules with so called “reverse pricing”, namely where for example low-priced buy orders are higher prioritized than higher-priced such orders and ranking rules including so called “wheels”, where for example all orders with the best price can share the privilege of matching with incoming orders regardless of time priority.

Thus, for this instrument and at the particular point in time illustrated, various participants in the market are willing to buy at a volume of 10 at a price of 100, 20 at 99 and 10 at 98. At the same time, participants in the market are willing to sell 5 of the instrument at a price of 102, 10 at 103 and 20 at 104. Since the market in this case is of a so-called anonymous type, no identities are given as to which participants are willing to buy or sell at the specified volumes or prices. The price difference between the most aggressive buyer, willing to pay 100, and the most aggressive seller, willing to sell at 102, in this case 102−100=2, is the current market spread for the instrument.

Using a client computer 1, each trading participant may, in an exemplifying embodiment, view the market for each instrument, in an orderbook fashion similar to the view given in FIG. 3, on the screen of the computer 1. This view is typically updated in realtime, through messages sent from the server computer 2 to each client computer 1 as a consequence of events changing the orderbook. Also, each participant can use a client computer 1 in order to enter orders into, or change or remove orders in the exchange systems, by the use of messages going from the client computer 1 to the server computer 2.

Thus, the server computer 2 continuously receives order entries, changes and removals from the various client computers 1 as a consequence of the actions of the individual participants. As the orderbook changes, the server computer 2 distributes updated order-book views for the traded instrument to client computers 1.

FIG. 4 illustrates the orderbook state just after a new buy order, for a volume of 10 at a price of 103, has been received by the server computer 2. Since this new order has a price which is better than the existing buy-side orders in the orderbook, it is ranked as the topmost buy-side order by the server computer 2. It is understood that the server computer 2 can check for possible matches before putting newly arrived orders into the orderbook, whereby only non-matched orders are put into the orderbook. However, for reasons of clarity, in the present exemplifying embodiment orders are put into the orderbook first, then checked for potential matches.

As is clear from the figure, there is a possible match between the newly received buy order and the existing sell-side orders in the orderbook. However, the server computer 2 does not create a trade using the matching orders, which would normally be the case instead of storing the newly arrived order in the orderbook. Instead, according to an exemplifying embodiment, they are marked in the orderbook, shown in FIG. 4 using arrows ‘>’ and ‘<’ to the left and to the right of each affected order, respectively. As is illustrated, the original sell-side order for 10 at 103 is furthermore split up into two parts, each with a volume of 5. This is because the newly received buy-side order at the price 103 has a volume of 10. In order for the server computer 2 to match orders together, it must obey the ranking rules described above. Thus, firstly the new order has to match the sell-side order for 5 at 102. This leaves an unmatched buy-side volume of 5, which is matched with the second-best sell side order for 10 at 103. However, only 5 of the volume of this latter order is needed to match the newly received order, which means that a sub volume of 5 of the sell-side order is left out of the match. In order to reflect this state, the sell-side order for 10 at 103 is split up into two parts, each for 5 at 103, and only one of the parts is used to indicate the possible match.

This marking of potentially matching orders in the orderbook defines a preliminary match of the marked orders. Instead of creating a final trade, thereby establishing a trade price and taking additional action such as preparations for clearing, settlement or the like, the server computer 2 merely marks the orders as being part of the preliminary trade. In one exemplifying embodiment, the markings are actually displayed to the participants on-screen on the client computers 1, in the form of arrows beside each marked order. However, depending on current demands on low bandwidth, information distribution, trading model, etc., the markings could just as well be completely internal to the server computer 2 and thus not at all visible to participants, or visible to only a subset of the participants, such as the participants involved in the preliminary trade. Likewise, the marked orders themselves could or could not be shown in the orderbook view for all participants, or they could be shown in the orderbook view for only a subset of all participants or to none of the participants. Such considerations are discussed in detail below.

Furthermore, according to another exemplifying embodiment, potentially matching orders are not placed in the orderbook in the first place, but are instead moved into a preliminary trade immediately upon reception at the server computer 2. In the present example, this would mean that the buy order for 10 at 103 would not be placed in the orderbook. Instead, the buy order and its counter orders in the defined preliminary trade could be grouped together outside of the orderbook. Possibly, once the preliminary trade is in place, the existence of the preliminary trade could then be marked in a suitable manner in the order-book, for example as shown in FIG. 4.

Upon creation of the preliminary trade, the server computer 2 may initiate a timer, keeping track of the amount of time passed since the creation of the preliminary trade. Upon the expiration of a predetermined time period, a final trade may then be created, as described below, based upon the current state of the preliminary trade. In this case, the length of the predetermined time period will greatly vary with such considerations as market type, participant profile, market liquidity, market depth, average latency in the automated exchange system, etc. In an exemplifying embodiment, it will be predetermined on the basis of the activity in the market for the traded instrument, so that an instrument with a very active market will be associated with a relatively short predetermined time period and vice versa. Here, the term “active market” is intended to mean that many orders per time unit are received by the server computer 2 for the instrument. Generally, the time period could according to this embodiment vary from milliseconds for intensively traded instruments to tens of minutes for less actively traded instruments.

If no other orders are received by the server computer 2 before the timer expires, in one exemplifying embodiment, a final trade is created at the expiry of the timer, using the current orders of the preliminary trade. In the case illustrated in FIG. 4, this would mean that the orders marked with an arrow would be part of the final trade. In other words, the buy-side order for a volume of 10 at a price of 103 would match against the two sell-side orders for 5 at 102 and 5 at 103, respectively. At the time of the creation of the final trade, a trade price would also be established. Such a trade price is usable in several ways, for example for distribution to all participants in the market as a measure of the current market price for the traded instrument and defining the price at which clearing and settlement should be conducted for the involved participants. The trading price may be established based upon the prices of the orders currently being part of the preliminary trade, at the time of the final trade. In the present example, this means that the trading price should be calculated using the same 3 orders being part of the preliminary trade as indicated above.

The method of calculation can vary. By way of example, it can be the best price of the orders on the market side of the aggressive order, which in this case would imply a trade price at 103, since the aggressive buy-side order for 10 at 103 is the best buy-side order being part of the preliminary trade. Similarly, the trade price can be calculated as the best non-aggressive price, which would mean that the trade price in this case should be 102. A third way to calculate the trade price would be to take the geometrical average of the best orders on the buy and sell sides, respectively, which would amount to choosing the middle of the market spread as the trade price. This would mean that the trade price in this case would be 102.5, being the average of 102 and 103, respectively. Any such method of calculating the trade price could be used, each having its advantages in terms of what type of participant is favoured by the trading state of the market and depending on the objects for the exchange system, as long as the trade price is established based upon the orders currently being part of the preliminary trade at the point in time when the final trade is created.

According to an exemplifying embodiment, in the created preliminary trade, if the price of a newly received order is better than that of an existing order on the same side of the market as the newly received order, at least part of the existing order or orders may be replaced for at least part of the newly received order, as described above. This mechanism will now be described in closer detail. However, it should be kept in mind that other variables than price could be used when determining which order is better than which, according to the above said, and consequently when a newly arrived order should replace an existing order in a preliminary trade.

FIG. 5 illustrates the situation when another order is received by the server computer 2 before the timer expires. In this case, the new order is a sell-side order for a volume of 10 at a price of 101. Thus, the newly received order is better priced than any of the existing sell-side orders in the orderbook. As can be seen in FIG. 5, the newly arrived order replaces the two existing sell-side orders in the preliminary trade. Hence, in the preliminary trade now there are only two orders—one for 10 at 103 on the buy side and one for 10 at 101 on the sell side. In FIG. 5, these orders are again marked using arrows. Also, the existing order for 10 at 103 is now no longer split up in two 5 volume parts, since the need for the split is no longer present in the new orderbook state. This rejoining of split orders may or may not be a part of the automated trading system, but is used here for reasons of simplicity.

Should the timer expire at the moment illustrated in FIG. 5, these two arrow-marked orders would be used in establishing the final trade price. However, FIG. 6 illustrates the situation if another order is received by the server computer 2. This new order is a buy-side order for 5 at 104. Since this new order is better priced than any of the existing buy-side orders being part of the preliminary trade, it will in the present exemplifying embodiment replace a part of the existing buy-side order that is part of the preliminary trade, the replaced part being as large as the volume of the newly received order, namely 5. The resulting situation is thus illustrated in FIG. 6, where arrows indicate that the new buy-side order for 5 at 104 is part of the preliminary trade along with a 5 volume part of the existing buy-side order for 10 at 103, which is now split up into two parts. Note that no changes are made to the sell side of the orderbook.

By the use of such replacements of orders being part of the preliminary trade, the final trade price is in fact improved for certain participants. In the case illustrated in FIG. 5, the new sell-side order actually renders the situation more favourable for the buy-side participant, since the sell-side order against which a match will be made once the final trade is created is better priced, at 101, than the previous sell-side order which used to be part of the preliminary trade, priced at 102. Depending on the method of calculating the final trade price, the buy-side participant will sometimes be better off, but will never be worse off by such a sell-side replacement in the preliminary trade.

In a similar way, the sell-side participant in a preliminary trade will sometimes be made better off, but will never be made worse off, by a buy-side replacement such as that illustrated in FIG. 6.

On the other hand, the buy-side participant in a preliminary trade could be thrown out of the preliminary trade, and therefore at a later stage also of the final trade, if another participant chooses to join the preliminary trade by entering an order effectively replacing an order of the original buy-side participant, such as is the case illustrated in FIG. 6. The corresponding is of course true for a sell-side participant in the preliminary trade, as illustrated in FIG. 5.

According to one exemplifying embodiment, in order to increase predictability for the participants in the preliminary trade, participants may be unable change or remove, partially or completely, an order being part of a preliminary trade. Should a participant choose to take such action, the timer would then be overruled, and a final trade would be created immediately, using the preliminary trade as-is at the time immediately prior to the attempted change or removal would be effected. The same would apply if an order being part of the preliminary trade expires, for example as a consequence of the expiration of its marketable time limit, or if the order is removed or changed for any other reason, such as by exchange staff. After the final trade is created, the change or removal operation would be applied. Hence, this may mean that the change or removal operation is in fact no longer possible, since the subject order may now have been removed from the orderbook because it was part of a final trade. On the other hand, part of the order may still be present in the orderbook, for example in case it has been split up into several parts as a consequence of a match in the preliminary trade, as described above.

In the exemplifying embodiment described above, a timer was initiated at the creation of the preliminary trade. The expiry of this timer served as a condition for creating a final trade using the orders being part of the preliminary trade. Such a condition may be used to define at what point in time the preliminary trade will form the basis for the creation of a final trade. However, such a condition needs not be in the form of a timer initiated at the creation of the preliminary trade.

Rather, a timer could just as well be initiated at the creation of a preliminary trade, and then be reinitiated at every complete or partial replacement of an order in the preliminary trade. This way, the final trade will be created at a time when no activity has occurred in the orders being part of the preliminary trade during a certain time, perhaps indicating that the most volatile phase of the price determination process as a response to the created preliminary trade has ended.

A possible variation on the same theme is a condition according to which a final trade will be created when a certain predetermined number of later orders for the instrument have been received since the creation of the original preliminary trade. The term “later order” is intended to include a third order, if such a third order has been received, as well as any received additional orders.

Another such possible variation is a condition in which a final trade will be created when a certain predetermined number of complete or partial replacements of orders have occurred in the preliminary trade since the creation of the original preliminary trade.

Another possible condition is that a final trade will be created when a market price for the instrument has changed by a larger amount than a predetermined value, as compared to the market price at the creation of the preliminary trade. Such a change in market price can be calculated using a method of calculating a trade price using the individual orders, as described above. In this case, the hypothetical trade price of the preliminary trade, should a final trade be created instantaneously, is calculated, and is compared to a previous trade price of the instrument or to the hypothetical final trade price for the original preliminary trade. The market price change could also use, for example, an external price achieved from an external trading venue trading the same instrument, as one or both of the two compared market price values. However, it is realized that any other suitable way of determining a change in market price of a traded instrument can be used.

Another possible condition is that a final trade should be created just before or at the time when the automatic exchange system changes the trading state for the instrument. Such a trading state change may include, for example, the end of continuous matching, the beginning of a specific auction market trading state with restricted access to order placement, etc. By the use of such a condition, the market risk associated with entering a new trading state with open positions is removed for the preliminary trade participants.

Another possible condition is that a final trade should be created as soon as an order is received that would normally have matched with an order which is part of the preliminary trade, but is not allowed to do so. This situation is described in detail below.

It is realized that other, similar, conditions for the creation of a final trade can be envisioned. Also, it is often feasible to use several different conditions in combination with each other, such as using a timer initiated at the creation of the preliminary trade combined with an additional condition that a final trade should be created in case the market price changes more than a certain predetermined percentage value, or using a timer initiated at the creation of the preliminary trade combined with an additional, shorter timer, being reinitiated at every order replacement, in which latter case any one of the timers expiring will trigger the creation of a final trade.

In an exemplifying embodiment, a timer, the length of which depends on the activity in the market for the instrument, is combined with a condition stipulating that a final trade should be created once a third order has been received. That is, if a third order is received, it either does or does not modify the preliminary trade, after which a final trade is created. However, if the timer expires before a third order is received, a final trade is created at this instance. In this exemplifying embodiment, no additional order is allowed to modify the preliminary trade, since a third order always implies the creation of a final trade.

Also, according to one exemplifying embodiment, some of the participants involved in the preliminary trade can, in certain cases, force the transformation of the preliminary trade into a final trade. This will to some extent protect the participants in the preliminary trade from excessive market risk in a volatile market. For example, such a transformation can be requested by the original aggressor of the preliminary trade, any participant on the same side of the market as the original aggressor, any participant having a topmost order in the preliminary trade, or by the use of any other condition as to what participant can request the transformation. Furthermore, the transformation may be available for request at any time, after a certain number of order replacements in the preliminary trade, after a certain number of newly received orders in the orderbook since the creation of the preliminary trade, after a certain time since the creation of the preliminary trade, or using any other suitable condition, as well as a combination of several such conditions.

A special situation occurs if one of the existing orders being part of the preliminary trade is partially or completely replaced for a more recent order, in case the resulting final trade, should it be created immediately after the replacement of the orders, would result in two orders on different sides of the market from the same participant being part of the same trade. In this case, the result would be a participant trading with himself as counterpart, effectively cancelling the effects of that part of the final trade.

FIG. 7 illustrates this situation. Given the situation in FIG. 6, the participant who originally entered the buy-side order for 5 at 104 has now also entered a new sell-side order for 5 at 100. The existing sell-side order for 10 at 101 is split up into two 5 volume parts, and one of them is replaced by the new sell-side order. Thus, the topmost order on each side of the market, each for a volume of 5 and marked using arrows in FIG. 7, are both entered by the same participant. Should a final trade be created in this instance, this participant would effectively trade with himself, which would in many cases be undesirable for the price determination process.

To illustrate this further, it is useful to think about what would happen if a final trade was to be created based upon the current state of the preliminary trade as illustrated in FIG. 7, and if the topmost order on each side of the market would not have been entered by the same participant. In this case, the price would be established, using some method of calculation, based upon orders priced at 103, 104, 100 and 101, respectively. If, on the other hand, the participant that has entered the topmost order on each side of the market is one and the same, or if the participant on behalf of whom these orders have been entered is one and the same, this price establishment is in some sense erroneous, since the part of the trade involving the orders priced at 104 and 100, respectively, will essentially not lead to anything substantial. Therefore, in an exemplifying embodiment, a final trade may instead be created immediately before the participant enters the order that could hypothetically lead to a final trade where the participant trades with himself.

However, it is realized that such a feature of the exchange system is not desirable in all cases. For example, in many known systems trading with oneself is never permitted. Such a rule would either lead to the impossibility for the participant to enter the new order in the first place, or to the impossibility for a final trade to be created with the two counter orders of the same participant. In these cases, an additional feature creating a final trade immediately before such a counter order is received may not make any sense. Also, in some systems trading with oneself is allowed, and may even be advantageous if, for example, trading costs are lower for such trading.

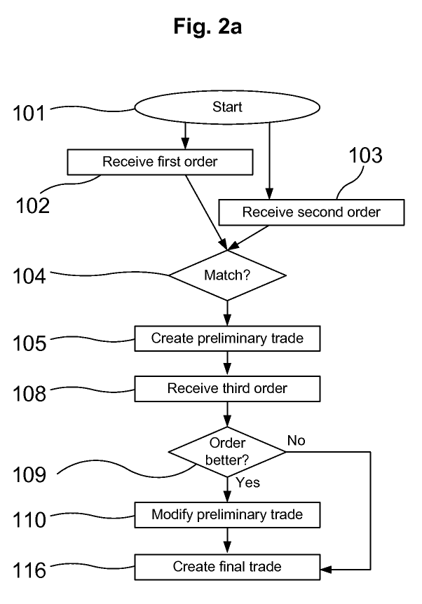

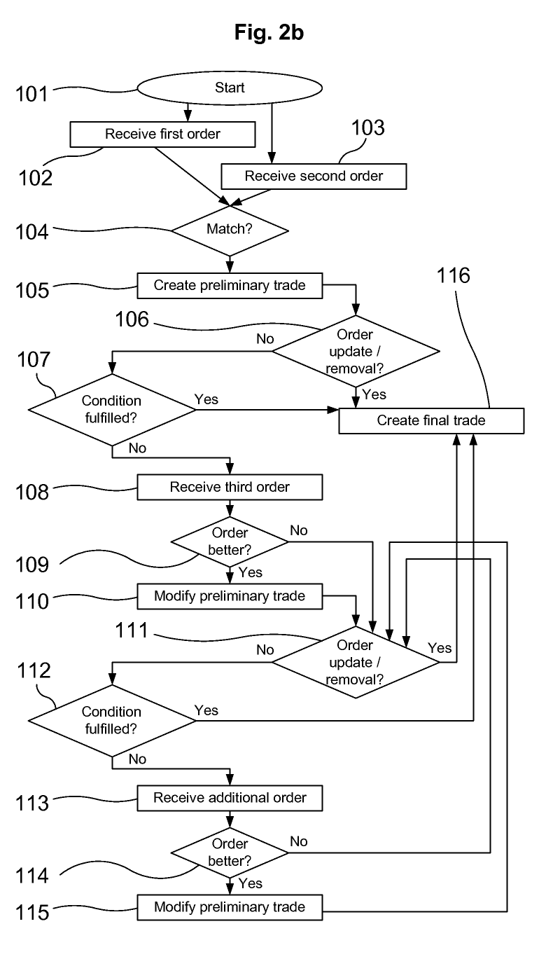

Furthermore, in the above described exemplifying embodiment, orders being part of a preliminary trade on both sides of the market can be replaced with more recently received, better priced orders. However, according to one exemplifying embodiment, some orders are blocked from modifying the preliminary trade, meaning that the reception of such blocked orders will not lead to the modification of the preliminary trade. In order to establish which orders are blocked, one may start by identifying a certain comparison order, which is the original non-aggressive order. Thus, the comparison order is the one order of the first and the second orders that was received first. Then, a condition may be set up, specifying that an order received after the creation of the preliminary trade will be blocked either if it is on the same side of the market as the comparison order or on the opposite side. Naturally, this applies both to the third order and to any additional orders, using the terminology of FIGS. 2a and 2b.

According to one exemplifying embodiment, only orders on the same side of the market as compared to the original non-aggressive order that originally matched the original aggressive order, said match leading to the creation of the preliminary trade, are allowed to be replaced in the preliminary trade at a later stage. This means that the sell-side order entered for a volume of 10 at a price of 101, giving rise to the preliminary trade state as illustrated in FIG. 5, would be allowed to replace the existing sell-side orders at price levels 102 and 103, respectively, as illustrated in FIG. 4, since this new order is on the other side (sell-side) of the market than that of the original aggressor order in the preliminary trade (the original buy-side order of 10 at 103, illustrated in FIG. 4). On the contrary, a new buy-side order for 5 at 104 would not be allowed to replace part of the existing buy-side order for 10 at 103, such as is illustrated in FIG. 6, since this new order is on the same side of the market (buy-side) as the original aggressor order.

Such a limitation, from now on called “non-aggressor-side replacement limitation”, as to what type of order is allowed to replace existing orders in the preliminary trade, reduces the market risk for the original aggressor whose order initiated the original preliminary trade. This participant will know that his final trade price will be at least as good as that originally entered in the aggressor order, and that he will run no risk of being thrown out of the preliminary trade before such a final trade is created.

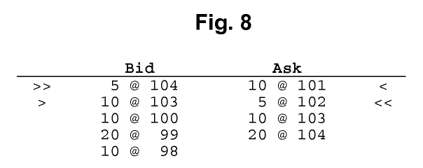

In the following, the case where such a limitation is used will be described in detail, with reference to the state of the preliminary trade such as shown in FIG. 5. If another participant enters a buy-side order for 5 at 104, the preliminary trade state illustrated in FIG. 6 is thus not allowed. Instead, according to an exemplifying embodiment, the server computer 2 will receive the new order and handle it as if a final trade would just have been created using the current preliminary trade. The resulting orderbook state is illustrated in FIG. 8. Hence, in this exemplifying embodiment, a second preliminary trade is created, whose respective orders are marked using double arrows “<<” and “>>”, respectively. Thus, the second preliminary trade has its own orders and conditions for creating a second final trade. This second preliminary trade is created using the newly received buy-side order for 5 at 104, and as the counter-order the existing sell-side order for a volume of 5 at a price of 102.

As more orders are received, they may replace existing orders in either the first or the second preliminary trade, in accordance with the rules used regarding what orders are allowed to be replaced, etc., as long as a certain preliminary trade has not formed the basis for the creation of a final trade. Also, in the present exemplifying embodiment, such replacements should pay respect to some set of priority rules ranking different preliminary trades and their respective orders. An exemplifying such set of priority rules according to the present invention states that newly received orders may replace orders being part of a preliminary trade, if such a replacement is possible for that particular preliminary trade order and under condition that the new order cannot replace an existing order in any other preliminary trade, where the other preliminary trade is older than the particular preliminary trade.

However, according to another exemplifying embodiment, the set of priority rules may rank preliminary trades higher in which the replacement-prone order with the worst price is part. This set of rules will in many cases lead to a more even price determination process.

According to another exemplifying embodiment, the set of priority rules may rank that preliminary trade higher in which the replacement-prone order which is oldest is part.

According to one exemplifying embodiment, an order can never be part of several preliminary trades at the same time. Namely, this would lead to situations where one order is part of several, hypothetical, future final trades, which may not be desirable for reasons of predictability in the market.

Above, a limitation as to what type of order is allowed to replace existing orders in the preliminary trade has been described. However, according to another exemplifying embodiment, only orders on the same side of the market as seen from the original aggressive order that originally matched an existing order in the orderbook, said match leading to the creation of the preliminary trade, may be allowed to be replaced in the preliminary trade at a later stage. This means that the sell-side order entered for a volume of 10 at a price of 101, giving rise to the preliminary trade state as illustrated in FIG. 5, would not be allowed to replace the existing sell-side orders at price levels 102 and 103, respectively, as illustrated in FIG. 4, since this new order is on the other side (sell-side) of the market than that of the original aggressor order in the preliminary trade (the original buy-side order of 10 at 103, illustrated in FIG. 4). On the contrary, a new buy-side order for 5 at 104 would be allowed to replace part of the existing buy-side order for 10 at 103, such as is illustrated in FIG. 6, since this new order is on the same side of the market (buy-side) as the original aggressor order.

Such a limitation, from now on called “aggressor-side replacement limitation”, will reduce the market risk for those participants being part of a preliminary trade on the non-aggressor side, at the expense of increased risk for the original aggressor and other participants acting on the same side of the market. Apart from this, this type of limitation is similar to what is described above in relation to the non-aggressor-side replacement limitation.

A variation of the replacement limitations is the non-aggressor-side replacement limitation as described above, but with an exception for the original aggressor. This means that the only participant whose orders would be allowed to replace existing orders of the preliminary trade on the same side of the market as the original aggressor order is the aggressor participant himself. In this way, the original aggressor can choose to sharpen his price in a preliminary trade, but will still not face the market risk of having his order or orders replaced by other participants' better priced orders.

Another variation of the replacement limitations is a limitation where the first actual replacement occurring in a particular preliminary trade may dictate what market side replacements will be allowable from that point onwards. Thus, if the first replacement of an order occurs on the original aggressor side of the market, only replacements on that side would be allowed in the future for that particular preliminary trade. If the first replacement, on the other hand, occurs on the non-aggressor side, the opposite would apply.

Thus, it may be possible for several preliminary trades to exist side by side at a given instant in time. However, this situation may not always be desirable. Several preliminary trades running in parallel might, for example, add too much complexity to the market. Thus, according to another exemplifying embodiment of the present invention, no such additional preliminary trades are allowed to be created apart from one already in place. In other words, new preliminary trades would be hindered from being created as long as there exists another preliminary trade in the market for a certain instrument which has not yet led to the creation of a final trade.

In order to accomplish this, some measure must be taken to handle newly received orders that match existing orders being part of the preliminary trade but that are not allowed to replace such existing orders. This can be done, by way of example, by letting these newly arrived orders immediately create final trades with existing orders in the orderbook that are not part of the preliminary trade in case such a match can be found, otherwise simply storing such newly arrived orders in the orderbook. Thus, a final trade would be created involving the orders marked using double arrows in FIG. 8, effectively sending them off the orderbook. As orders being part of a preliminary trade are replaced, and restored in the orderbook, such replaced orders then would have the ability to match and therefore immediately and finally trade with existing non-preliminary trade counter orders in the order-book. Naturally, orders that have been part of a preliminary trade before they were replaced and restored in the orderbook may be available for matching with other orders once a final trade has been created and the preliminary trade therefore does no longer exist, regardless of whether several parallel preliminary trades are allowed or not.

According to another exemplifying embodiment, newly received orders may be put into a queue until a final trade is created. Thereafter, the orders in the queued may be handled one at a time in order of appearance in the queue, and be treated as if they would have been received by the server computer 2 at that point in time.

According to yet another exemplifying embodiment, the reception of new orders that are not allowed to match orders in the preliminary trade according to the above may force the creation of a final trade based upon the preliminary trade.

As described above, orders may be of an order type allowing orders to be stored in the orderbook in case they do not match any counter orders immediately, for example so-called limit orders. Other order types, notably so-called market orders, may in some trading systems never be stored in the orderbook. Rather, they are either matched immediately or discarded by the server computer 2. According to an exemplifying embodiment, orders of such order types not legit for storing in the orderbook cannot be part of a preliminary trade. This conserves the immediate, low-risk profile of such orders, not adding the market risk of such an order given a prolonged presence in the market. Thus, non-market orders being part of a preliminary trade would in this case not be open for matching with market orders, but would be regarded as orders already finally traded from the viewpoint of the participant entering the market order.

According to another exemplifying embodiment of the present invention, fill-and-kill orders and fill-or-kill orders may be handled in a manner similar to that of market orders. Thus, such orders would not be able to be part of a preliminary trade, and to them, orders being part of a preliminary trade are not open for matching.

Some markets use so-called pegged orders, being orders whose price depends on a certain external variable, such as the market price of an instrument on an external market. Hence, pegged orders can change their price if the price of the external variable changes. According to an exemplifying embodiment of the present invention, a price change of a pegged order being part of a preliminary trade may be handled, by the server computer 2, as if a new order had been entered, by the same participant that entered the pegged order in the first place, for the same volume but at the new pegged price. Hence, the new order may replace the original pegged order if the new price is more aggressive, in accordance to the used limitation rules regarding allowable replacements described above. In this case, the volume of the old order would preferably be reset to zero by the server computer 2, in order for that order not to match against any counter order in the preliminary trade. On the other hand, if the new pegged price is less aggressive than the previously pegged price, the price change would be handled as a removal of the order and the consequent entering of a new order at the new price. This could, according to what has been described above, lead to a final trade being created using the preliminary trade orders just before the removal of the pegged order, and hence possibly to the removal of the pegged order from the orderbook altogether.

In other words, pegged orders may improve their price and still be part of a preliminary trade, but as soon as their pegged price is about to worsen, a final trade could be created before the actual worsening of the price.

As described above, the server computer 2 may continuously send out information to the individual client computers 1 regarding the state of the market. Such information can be sent out to all client computers 1 in the market, reflecting that such information is public to all participants, or to a subset of the client computers 1, reflecting a certain information privacy. It is thus possible for the information regarding the development of a certain preliminary trade and its associated final trade to be distributed only to a subset of client computers 1, such as only to those participants having orders being part of the preliminary trade in question, keeping the data traffic load down in the automated exchange system. However, it is preferred that such information is distributed to all client computers 1, in order to increase transparency in the market and to enhance the aggregated price determination process. In particular, if the market as a whole does not receive information about the creation of a preliminary trade, the publicly distributed orderbook image would, in case orders being part of a preliminary trade are not part of this image, not include information about the possibility to enter into the preliminary trade, or, in case such orders are part of this image, include apparently matching orders still in the orderbook, possibly confusing participants acting in the market. Also, the opportunity to join a preliminary trade, together with the publicly distributed image of an ongoing preliminary trade, is in many cases an incentive for providing more liquidity to the market, whereby distributing a publicly available orderbook image comprising any preliminary trades increases market liquidity.

According to one exemplifying embodiment, the server computer 2 or the client computers 1 may provide each participant with the option to allow or not allow each entered order to be part of a preliminary trade in the market. Thus, orders not eligible for preliminary trading would only be available for immediate creation of final trades or possibly storage in the orderbook. For these orders, counter orders being part of a preliminary trade would be handled precisely as if they were already finally traded and removed from the orderbook. Preliminary trade orders being replaced by newly received orders, thereby no longer part of a preliminary trade, would of course again be potential counter orders for matching with the non-eligible order. In this way, participants are presented with the possibility of increased control over their respective orders, risk exposure and possibility of price improvement for entered orders.

Thus, an improved method for trading an instrument in an automated exchange system is provided, whereby market participants are awarded for providing liquidity to the market and whereby incentives for increasing the volume traded are present. This is accomplished by a price establishment process which is delayed as compared to the conventional way of trading instruments in automated exchange systems. Once a potential match has been identified, the matching orders are moved into a preliminary trade state, during which the server computer 2 checks for possible price-affecting market events, in terms of new orders being entered for the instrument. If such price-affecting market events do occur, the original participants can take advantage of them according to a set of rules defining who takes the risk and who will gain the advantage of potential price improvements. If, on the other hand, no such events occur, the originally identified match becomes a final trade. Market events can also be harmful for a participant of a preliminary trade, if an order of the participant for example is replaced by a new, better priced, order. However, in this case the participant would not loose any money due to a worse trade price than expected; the order may merely be put back into the orderbook awaiting the next potential match. Thus, the potential of price improvement can be carefully weighted against limited and transparent market risk.

Therefore, the automated exchange system makes it possible for the market to award liquidity providers by providing potential price improvements in the market. At the same time, the possibility of potential price improvement at the cost of limited risk raises the general attractiveness of the exchange market, leading to higher trading volumes in the market.

Furthermore, by the use of preliminary trades, existing during certain time periods before final trades are created, increases the smoothness of the price discovery process, since trading participants gain time to assess the new market situation introduced by a new match between two orders.

Finally the automated exchange system is completely automatic, and does not require individual market participants to take additional or excessive action in a manual manner in order to be able to exploit certain privileges associated with liquidity providers in the market. In other words, the price of an order may or may not be improved, without the involvement of any required additional action on behalf of the participant. This makes the advantages available to a broader range of investors.

Above, preferred example embodiments have been described. However, it will be apparent for the person skilled in the art that many alterations can be made to the described embodiments. Thus, the technology described should not be limited by the described embodiments, but could rather be modified within the scope of the enclosed claims.

1. A method for trading an instrument in an automated trading exchange system, comprising the steps of:
(a) electronically receiving a first order for the instrument on a first side of a market;
(b) electronically receiving a second order for the instrument on a second side of said market;
(c) electronically evaluating by a processor the first and the second orders regarding the possibility for a match between the first and the second orders;
(d) if such a match is possible, electronically creating by a processor a preliminary trade using the first and the second orders, where a preliminary trade means that the automated trading exchange system makes a note about a possible trade between the first and the second orders, and reserves the corresponding volume of the first and second orders, respectively, but does not accomplish a final trade;
(e) electronically receiving a third order for the instrument on the first side of the market;
(f) electronically comparing the third order with the first order;
(g) if the third order is better than the first order, electronically modifying by a processor the preliminary trade; and
(k) electronically creating by a processor a final trade using the orders currently being part of the preliminary trade such that a trade price is established in the market, and that instructions are generated for the further processing of the final trade, such as clearing and/or settlement.

2. The method according to claim 1, where at step (k) a price of the final trade is determined based upon the prices of the orders currently being part of the preliminary trade, respectively, at the time of the creation of the final trade.

3. The method according to claim 1, further comprising the following steps after step (g) but before step (k):
(a) receiving an additional order for the instrument on a certain side of the market;
(b) comparing the additional order with a certain best order, which is the best order currently being part of the preliminary trade on the same side of the market as the additional order; and
(c) if the additional order is better than the certain best order, modifying the preliminary trade;
where steps (h)-(j) are allowed to repeat before step (k) is initiated.

4. The method according to claim 3, where at step (k) a price of the final trade is determined based upon the prices of the orders currently being part of the preliminary trade, respectively, at the time of the creation of the final trade.

5. The method according to claim 3, comprising the additional step of receiving a message transaction with instructions leading to the partial or complete removal, or update, of any of the orders currently being part of the preliminary trade, and where, upon the execution of the message transaction, step (k) is completed before said execution.

6. The method according to claim 3, where step (k) is initiated immediately at the fulfillment of a stop condition, which stop condition is one or a combination of several of the following:
i) a certain predetermined time period has elapsed since the creation of the preliminary trade;
ii) a certain predetermined time period has elapsed since the last modification of the preliminary trade;
iii) a certain predetermined number of later orders, including any third or additional orders, for the instrument have been received since the creation of the preliminary trade;
iv) a certain predetermined number of modifications of the preliminary trade have occurred since the creation of the preliminary trade;
v) a market price for the instrument has changed by a larger amount than a predetermined value;
vi) a message transaction has been received with instructions leading to the transformation of the preliminary trade into a final trade; or
vii) the trading state for the instrument has been or is about to be changed viii) an order is received that would normally match an order in the preliminary trade, where the said order is blocked from modifying the preliminary trade.

7. The method according to claim 6, where the stop condition is a combination of the following:
i) a certain predetermined time period, the length of which is determined based upon the activity in the market for the instrument so that the time period is longer for instruments with less active markets and vice versa, has elapsed since the creation of the preliminary trade; and
ii) a certain predetermined number of later orders, including any third and additional orders, have been received since the reception of the first and the second orders, preferably 1 such later order.

8. The method according to claim 3, where steps (g) and (j), respectively, also comprise the step of immediately proceeding to the step (k) in case the preliminary trade is about to be modified in such a way that the resulting final trade, should it be created immediately after the modification of the orders, would result in two orders being part of the same trade, on different sides of the market and entered into the system by or on behalf of one and the same trading participant.

9. The method according to claim 3, where a comparison order is taken to be the one order of the first and the second orders which is received first, where steps (f) and (i), respectively, comprise the additional step of applying a certain order condition to a received later order, such as a third or additional order, and if the later order satisfies the order condition, blocking it from modifying the preliminary trade at step (g) or (j), where the order condition at least comprises that the later order is on a certain side of the market.

10. The method according to claim 9, where the order condition is one of the following:
(a) the later order is on the same side of the market as the comparison order; or
(b) the later order is on the opposite side of the market as compared to the comparison order.

11. The method according to claim 9, where each of the first order, the second order and the later order are entered by or on behalf of a first, a second and a third trading participant, respectively, and where the order condition is that firstly, the later order is on the opposite side of the market as compared to the comparison order, and that, secondly, the third participant is not the same as the participant of the one order of the first and the second orders which was received last.

12. The method according to claim 9, where step (j) comprises the additional step of, at the time of the first modification of the preliminary trade, determining the side of the market of the most recently received later order the reception of which led to a modification of the preliminary trade, and where from that point on, the order condition is that an additional order received at a later time is on the opposite side of the market as compared to said determined side.

13. The method according to claim 9, where a certain later order is blocked from modifying a preliminary trade, where an order which is part of a preliminary trade is unavailable for matching with said certain later order, and where an order, which as a consequence of a modification of the preliminary trade no longer is part of a preliminary trade, is again available for matching with said certain later order.

14. The method according to claim 3, where market priced orders are blocked from modifying the preliminary trade at steps (g) and (j), respectively.

15. The method according to claim 3, where the price of an order which is part of a preliminary trade is pegged to an external price, and a change in the price of the pegged order, being the consequence of a change in the external price, is treated as the reception of a later order, such as a third or additional order, with the new pegged price.

16. The method according to claim 1, where the instrument is traded in a continuous auction market.

17. A computer program stored on a non-transitory, computer-readable medium in a programmed server computer, which computer program when executed by the server computer causes the server computer to execute the steps (a)-(k) according to claim 1.

18. An automated trading exchange system for trading an instrument, comprising at least one programmed server computer, configured to receive and manage buy and sell orders for said instrument, where the server computer is configured to:
(a) receive a first order for the instrument on a first side of a market;
(b) receive a second order for the instrument on a second side of said market;
(c) evaluate the first and the second orders regarding the possibility for a match between the first and the second orders;
(d) if such a match is possible, create a preliminary trade using the first and the second orders such that the automated trading exchange system makes a note about a possible trade between the first and the second orders, and reserves the corresponding volume of the first and second orders, respectively, but does not accomplish a final trade;
(e) receive a third order for the instrument on the first side of the market;
(f) compare the third order with the first order;
(g) if the third order is better than the first order, modify the preliminary trade; and
(k) create a final trade using the orders currently being part of the preliminary trade such that a trade price is established in the market and instructions are generated for the further processing of the final trade including one or both of clearing and settlement.

19. The system according to claim 18, where the server computer is further configured to determine a price of the final trade based upon the prices of the orders currently being part of the preliminary trade, respectively, at the time of the creation of the final trade.

20. The system according to claim 18, where the server computer is further configured to carry out the following tasks after (g) but before (k):
(h) receive an additional order for the instrument on a certain side of the market;
(i) compare the additional order with a certain best order, which is the best order currently being part of the preliminary trade on the same side of the market as the additional order; and
(j) if the additional order is better than the certain best order, modify the preliminary trade; where the server computer is configured to allow (h)-(j) to repeat before (k) is initiated.

21. The system according to claim 20, where the server computer is configured to, at (k), determine a price of the final trade based upon the prices of the orders currently being part of the preliminary trade, respectively, at the time of the creation of the final trade.

22. The system according to claim 20, where the server computer is configured to receive a message transaction with instructions leading to the partial or complete removal, or update, of any of the orders currently being part of the preliminary trade, and where the server computer is configured to complete (k) before the execution of said message transaction.

23. The system according to claim 20, where the server computer is further configured to initiate (k) immediately at the fulfillment of a stop condition, which stop condition is one or a combination of several of the following:
i) a certain predetermined time period has elapsed since the creation of the preliminary trade;
ii) a certain predetermined time period has elapsed since the last modification of the preliminary trade;
iii) a certain predetermined number of later orders, including any third and additional orders, for the instrument have been received since the creation of the preliminary trade;
iv) a certain predetermined number of modifications of the preliminary trade have occurred since the creation of the preliminary trade;
v) a market price for the instrument has changed by a larger amount than a predetermined value;
vi) the server computer has received a message transaction with instructions leading to the transformation of the preliminary trade into a final trade; or
vii) the trading state for the instrument has been or is about to be changed.
viii) an order is received that would normally match an order in the preliminary trade, where the said order is blocked from modifying the preliminary trade.

24. The system according to claim 23, where the stop condition is a combination of the following:
i) a certain predetermined time period, the length of which is determined based upon the activity in the market for the instrument so that the time period is longer for instruments with less active markets and vice versa, has elapsed since the creation of the preliminary trade; and
ii) the server computer has received a certain predetermined number of later orders, including any third and additional orders, for the instrument since the reception of the first and the second orders, preferably 1 such later order.

25. The system according to claim 20, where the server computer is further configured to, at (g) and (j), respectively, immediately proceed to the (k) in case the preliminary trade is about to be modified in such a way that the resulting final trade, should it be created immediately after the modification of the orders, would result in two orders being part of the same trade, on different sides of the market and sent to the server computer by or on behalf of the same trading participant.

26. The system according to claim 20, where the server computer is further configured to take a comparison order to be the one order of the first and the second orders which is received first by the server computer, and at (f) and (i) respectively, apply a certain order condition to a received later order, such as a third or additional order, and if the later order satisfies the order condition, block it from modifying the preliminary trade at (g) or (i), where the order condition at least comprises that the later order is on a certain side of the market.

27. The system according to claim 26, where the order condition is one of the following:
(a) the later order is on the same side of the market as the comparison order; or
(b) the later order is on the opposite side of the market as compared to the comparison order.

28. The system according to claim 26, where the server computer is further configured to receive each of the first order, the second order and the later order in the form of a message transaction sent by or on behalf of a first, a second and a third trading participant, respectively, and where the order condition is that firstly, the later order is on the opposite side of the market as compared to the comparison order, and that, secondly, the third participant is not the same as the participant of the one order of the first and the second orders which was received last by the server computer.

29. The system according to claim 26, where the server computer is further configured to, at the time of the first modification of the preliminary trade, determine the side of the market of the most recently received later order the reception of which led to a modification of the preliminary trade, and where from that point on, the order condition is that an additional order received at a later time is on the opposite side of the market as compared to said determined side.

30. The system according to claim 26, where the server computer is configured to block a certain later order from modifying a preliminary trade, where the server computer is further configured to render an order being part of a preliminary trade unavailable for matching with said certain later order, and to again render an order, which as a consequence of a modification of the preliminary trade no longer is part of a preliminary trade, available for matching with said certain later order.

31. The system according to claim 20, where the server computer is further configured to block market priced orders from modifying the preliminary trade at (g) and (j), respectively

32. The system according to claim 20, where the server computer is further configured to peg the price of an order which is part of a preliminary trade to an external price, and to treat a change in the price of the pegged order, being the consequence of a change in the external price, as the reception of a later order, such as a third or additional order, with the new pegged price.

33. The system according to claim 18, where the automated trading exchange system is a continuous auction market in which the instrument is traded.
